(19) United States
(12) Patent Application Publication
(10) Pub. No.: US 2016/0140762 A1
(43) Pub. Date: May 19, 2016

(54) IMAGE PROCESSING DEVICE AND IMAGE PROCESSING METHOD

(71) Applicant: FUJITSU LIMITED, Kawasaki-shi (JP)

(72) Inventors: Koichiro NIINUMA, Kawasaki (JP); Takahiro Matsuda, Isehara (JP)

(73) Assignee: Fujitsu Limited, Kawasaki-shi (JP)

(21) Appl. No.: 14/855,701

(22) Filed: Sep. 16, 2015

(30) Foreign Application Priority Data
Nov. 18, 2014 (JP) 2014-233391

(51) Int. Cl. G06T 19/00; G06F 3/01; G06K 9/00

(52) U.S. Cl. CPC G06T 19/006; G06K 9/00201; G06F 3/017

(57) ABSTRACT

An image processing device includes: a processor; and a memory which stores a plurality of instructions, which when executed by the processor, cause the processor to execute: acquiring an captured image including a recognition target object in a real world and an operation part of a user; recognizing the recognition target object and the operation part from the captured image; displaying an additional information image including information corresponding to the recognition target object; and determining, based on the amount of change in a feature amount of the operation part in the captured images, whether a motion of the operation part is directed at the recognition target object or is directed at the additional information image.

### CROSS-REFERENCE TO RELATED APPLICATION

This application is based upon and claims the benefit of priority of the prior Japanese Patent Application No. 2014-233391, filed on Nov. 18, 2014, the entire contents of which are incorporated herein by reference.

### FIELD

The embodiments discussed herein are related to, for example, an image processing device, an image processing method, and an image processing program, which are each used for displaying an additional information image that serves as work support information for a user and that corresponds to a recognition target object in a real world.

### BACKGROUND

In recent years, with the development of information and communication technologies, an image processing technology related to augmented reality (AR) has been developed, the image processing technology being used for adding, using a computer, visual information to an image, obtained by imaging a real space (real world), and displaying the image. A wearable device such as a head mounted display (HMD) equipped with a camera for acquiring images of the real world, a tablet terminal equipped with a camera, or the like is mainly used for displaying the visual information, and detailed information (hereinafter, called an additional information image (a virtual world image)), related to a recognition target object that exists in a visual field direction of a user, is displayed while being associated with the position of the recognition target object in the real world.

Currently a technology that utilizes an augmented reality technology is realized, the technology being used for supporting identification of a failure point at the time of the occurrence of a failure of an electronic device or the like and failure recovery work of a user. A technology for superimposing and displaying, in a copying machine serving as a recognition target object, an internal video picture and an operational procedure image of the copying machine in recovery work support to, for example, a paper jam failure of the copying machine is proposed, the internal video picture and the operational procedure image serving as the additional information images and being prepared in advance while being associated with the position of the occurrence of the paper jam. In addition, as for maintenance and inspection in a factory or field work such as equipment installation or dismantlement, work support utilizing the augmented reality is proposed.

In work support to a user, since the user works using both hands in many cases, utilization of the hands-free HMDs is more highly desired than that of tablet terminals, the HMDs being mountable on head parts. The HMDs are roughly classified into a video see-through HMD in which a recognition target object included in a captured image of a camera and an additional information image are displayed in a display unit such as a display and an optical see-through HMD in which an additional information image is displayed in a display unit while being associated with the position of a recognition target object in the real world by using a half mirror, the recognition target object being visually recognized by a user. In addition, a small-screen HMD, in which a miniature display is arranged in an edge portion of the visual field of a user and an additional information image is displayed in the miniature display, is proposed. Note that the video see-through HMD and the optical see-through HMD are each able to use the small-screen HMD. In each of the above-mentioned HMDs, work support based on the augmented reality is desired. As a related document, for example,” Harrison, C et al., “Wearable Multitouch Interaction Everywhere”, UIST'11, Oct. 16-19, 2011, Santa Barbara, Calif., USA” or the like is cited.

### SUMMARY

In accordance with an aspect of the embodiments, animage processing device includes: a processor; and a memory which stores a plurality of instructions, which when executed by the processor, cause the processor to execute: acquiring an captured image including a recognition target object in a real world and an operation part of a user; recognizing the recognition target object and the operation part from the captured image; displaying an additional information image including information corresponding to the recognition target object; and determining, based on the amount of change in a feature amount of the operation part in the captured images, whether a motion of the operation part is directed at the recognition target object or is directed at the additional information image.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1A is a first conceptual diagram of a recognition target object and an additional information image, and FIG. 1B is a second conceptual diagram of the recognition target object and an additional information image;

FIG. 2 is a functional block diagram of an image processing device according to one embodiment;

FIG. 3 is a flowchart of image processing in the image processing device;

FIG. 4 is a first hardware configuration diagram of the image processing device according to one embodiment;

FIG. 5 is a flowchart of recognition processing of a recognition target object in a recognition unit;

FIG. 6 is a table illustrating an example of a data structure including hand-finger coordinates in a camera coordinate system, calculated by a calculation unit;

FIG. 7 is a diagram illustrating an example of a table including a data structure of feature amounts of an operation part, the amounts of change in the feature amounts of the operation part, and a position of a recognition target object, calculated by the calculation unit; and

FIG. 8 is a hardware configuration diagram of a computer that functions as the image processing device according to one embodiment.

### DESCRIPTION OF EMBODIMENTS

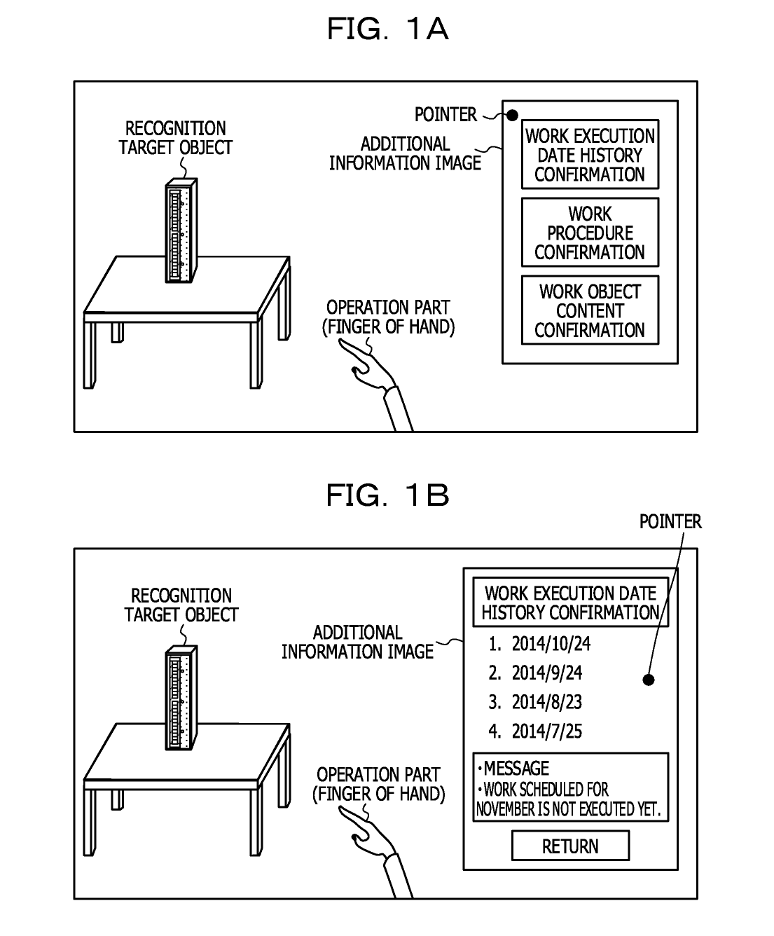

First, whereabouts of problems in a related technology will be described. Note that the whereabouts of problems are newly found as a result of detailed study of the related technology by the present inventors and have not been known in the past. In an image processing device that utilizes any HMD of the video see-through HMD and the optical see-through HMD, there is a problem in an input interface for an additional information image corresponding to a recognition target object displayed in a display unit in the HMD. FIG. 1A is a first conceptual diagram of a recognition target object and an additional information image. FIG. 1B is a second conceptual diagram of the recognition target object and an additional information image. FIGS. 1A and 1B each include the additional information image displayed in a display unit in an HMD, a recognition target object in the real world, and a finger of a hand, which serves as an example of an operation part of a user. The additional information image in FIG. 1A includes selection items (“work execution date history confirmation”, “work procedure confirmation”, and “work object content confirmation”) corresponding to the recognition target object, and in a case where the user selects one of the selection items by superimposing a pointer (may be called a mouse cursor) thereon, the additional information image corresponding to the selected selection item is displayed as illustrated in FIG. 1B. In the examples illustrated in FIG. 1A and FIG. 1B, the pointer is superimposed on the “work execution date history confirmation” in FIG. 1A, thereby making a transition to the additional information image for confirming the detail of the work execution date history, illustrated in FIG. 1B. As seen from FIGS. 1A and 1B, in a case of performing, on the additional information image, some kind of operation such as selection of a selection item, control or the like of the pointer is desired. In the present, using an external controller, connected to the HMD and controlled by a manual operation of the user, the pointer is moved. However, the manual operation based on the external controller has to be implemented using both hands or one hand. Therefore, the manual operation is a limiting factor for advantages (improvement of a work efficiency and so forth) of utilization of the hands-free HMD. Therefore, in the present, there is a state in which an image processing device capable of adequately displaying the additional information image without reducing the work efficiency is not proposed.

In order to take advantage of the hands-free HMD, an operation of a pointer, which uses, for example, recognition of a gesture of a finger of a hand, may be considered so as to adequately display the additional information image. If using, for example, a fingertip, a pointer is operated, thereby enabling a selection item of the additional information image to be selected, the manual operation of the pointer based on the external controller is unneeded. From this, it becomes possible for the user to seamlessly switch between work in which a recognition target object that exists in the real world is an operation target and work in which the additional information image is an operation target.

A finger of a hand, which serves as an example of an operation part of the user, may be recognized using an imaging device, for example, a camera (may be called a head mounted camera (HMC)) mounted in the HMD and a known recognition method. However, a finger of a hand of the user is reflected in an image captured by the imaging device not only at the time of the operation of the pointer, which corresponds to the additional information image, but a finger of a hand is reflected also during work for a recognition target object in the real world. Therefore, it is desirable to identify whether an operation target of a finger of a hand of the user, which serves as an example of an operation target of the operation part of the user, is the additional information image or the recognition target object. If the identification is not performed, it is conceivable that there occurs, for example, a trouble that the pointer moves in accordance with the position of a fingertip in spite of the user's work on, for example, the recognition target object in the real world and a selection item of the additional information image turns out to be unintentionally selected.

In other words, if it becomes possible to identify whether the motion of the operation part of the user is directed at the additional information image or the recognition target object, it becomes possible to seamlessly switch between work in which the recognition target object that exists in the real world is an operation target and work in which the additional information image is an operation target. From this, it becomes possible to provide an image processing device capable of adequately displaying the additional information image without reducing the work efficiency.

While taking into consideration problems newly found out by earnest verification of the present inventors, hereinafter examples of an image processing device, an image processing method, and an image processing program according to one embodiment will be described in detail, based on drawings. Note that the examples do not limit the disclosed technology.

### First Example

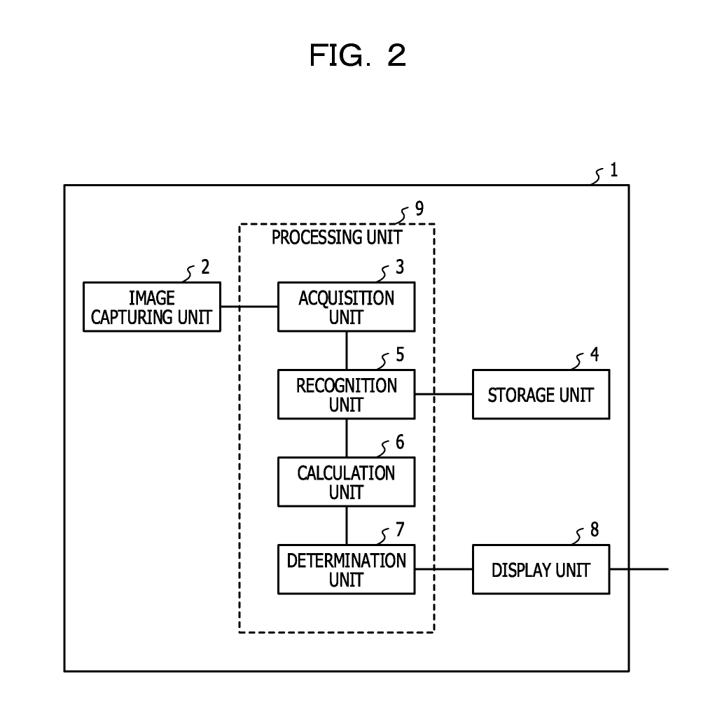

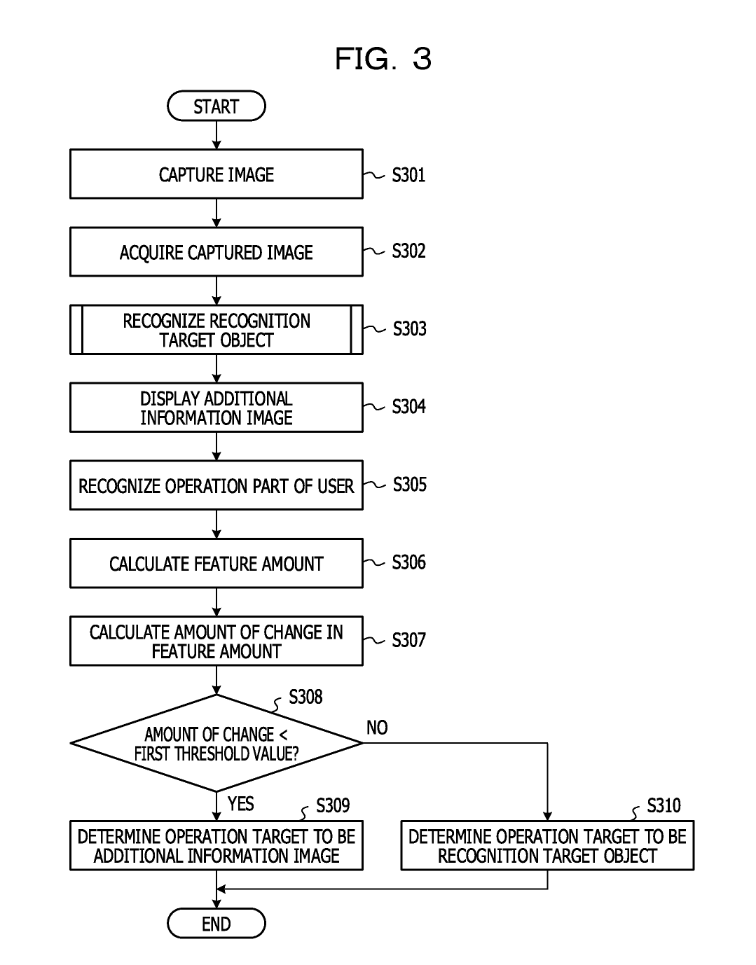

FIG. 2 is a functional block diagram of an image processing device 1 according to one embodiment. The image processing device 1 includes an image capturing unit 2, a storage unit 4, a display unit 8, and a processing unit 9. The processing unit 9 includes an acquisition unit 3, a recognition unit 5, a calculation unit 6, and a determination unit 7. FIG. 3 is a flowchart of image processing in the image processing device 1. In the first example, a flow of the image processing based on the image processing device 1, illustrated in FIG. 3, will be described while being associated with descriptions of individual functions in a functional block diagram of the image processing device 1 illustrated in FIG. 2.

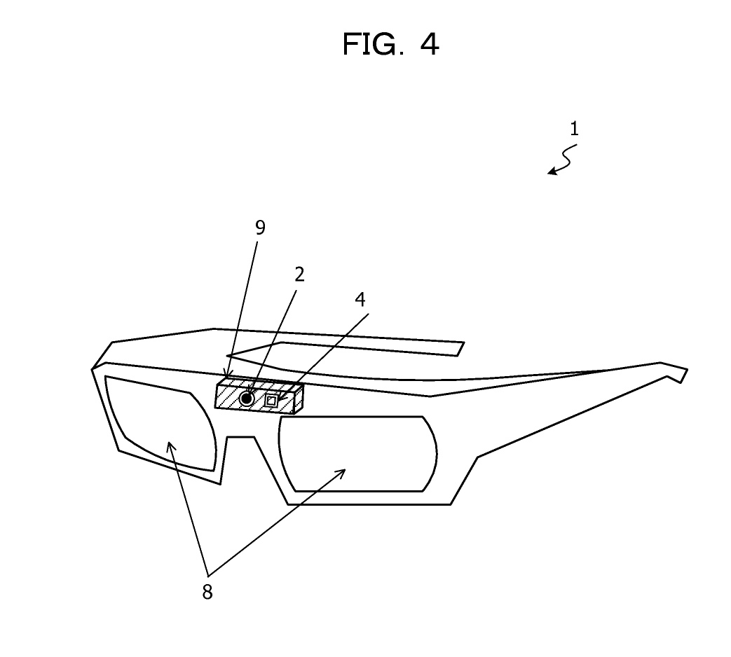

FIG. 4 is a first hardware configuration diagram of the image processing device 1 according to one embodiment. As illustrated in FIG. 4, the image capturing unit 2, the storage unit 4, the display unit 8, and the processing unit 9 in the image processing device 1 are fixedly installed in, for example, a glasses frame type support. Note that the image capturing unit 2 may be fixedly installed in such a manner as being located midway between both eyes so that a user easily identifies a recognition target object at which the user looks fixedly in the real world (may be called an outside world). In addition, while not illustrated, a stereoscopic image may be used by fixedly arranging two or more image capturing units 2. While the details of the display unit 8 will be described later, it is possible to use an optical see-through display such as a half mirror, which has given reflectance and transmittance, so that the user is able to visually recognize the real world. Note that the video see-through HMD that displays, in the display unit 8 such as a display, an additional information image corresponding to a recognition target object in a captured image of a camera in the display unit 8 may be used. In the first example, for convenience of explanation, a case where the optical see-through display is applied will be described.

In FIG. 2 or FIG. 4, the image capturing unit 2 is an imaging device such as, for example, a charge coupled device (CCD) or complementary metal oxide semiconductor (CMOS) camera. The image capturing unit 2 is fixedly supported by or attached on, for example, the cervical part of the user and captures an image (the relevant image may be called a captured image) in the visual field direction of the user. In addition, the image capturing unit 2 may capture imagers at a time interval of, for example, 30 fps. Note that the relevant processing corresponds to a step S301 in a flowchart illustrated in FIG. 3. While being arranged within the image processing device 1 for convenience of explanation, the image capturing unit 2 may be arranged outside of the image processing device 1 so as to be accessible via a network. The image capturing unit 2 captures an image including a recognition target object serving as a work target of the user and an operation part of the user. The image capturing unit 2 outputs, to the acquisition unit 3, the captured image including the recognition target object and the operation part of the user.

The acquisition unit 3 is, for example, a hardware circuit based on hard-wired logic. In addition, the acquisition unit 3 may be a functional module realized by a computer program executed by the image processing device 1. The acquisition unit 3 receives, from the image capturing unit 2, the captured image including the recognition target object and the operation part of the user. Note that the relevant processing corresponds to a step S302 in the flowchart illustrated in FIG. 3. In addition, it is possible to cause the acquisition unit 3 to merge the function of the image capturing unit 2. The acquisition unit 3 outputs, to the recognition unit 5, captured images including the recognition target object and the operation part of the user.

The storage unit 4 is a storage device such as, for example, a semiconductor memory element such as a flash memory, a hard disk, or an optical disk. Note that the storage unit 4 is not limited to the above-mentioned types of storage device and may be a random access memory (RAM) or a read only memory (ROM). Feature points (may be called first feature points or a first feature point group) of recognition target objects (an electronic circuit board, a manufacturing equipment, an information processing terminal, and so forth) that exist in the outside world and serve as targets of recognition processing in the recognition unit 5 are preliminarily extracted from images obtained by preliminarily imaging recognition target objects and stored in the storage unit 4. In addition, in the storage unit 4, additional information images corresponding to the recognition target objects may be stored. Furthermore, the additional information images stored in the storage unit 4 do not have to have a one-to-one relationship with the recognition target objects and additional information images for one of the additional information images may be stored.

Note that while being arranged within the image processing device 1 for convenience of explanation, the storage unit 4 may be arranged outside of the image processing device 1 so as to be accessible via the network. In addition, in the storage unit 4, after-mentioned various kinds of programs to be executed by the image processing device 1, for example, basic software such as an operating system (OS) and a program in which the operation of image processing is specified are stored. Furthermore, in the storage unit 4, various kinds of data to be used for execution of the relevant programs are stored as appropriate. In addition, a configuration in which the various kinds of data stored in the storage unit 4 are arbitrarily stored in, for example, memories or caches in the recognition unit 5, the calculation unit 6, and determination unit 7, not illustrated, and the image processing device 1 does not use the storage unit 4 may be adopted.

The recognition unit 5 is, for example, a hardware circuit based on hard-wired logic. In addition, the recognition unit 5 may be a functional module realized by a computer program executed by the image processing device 1. The recognition unit 5 receives captured images from the acquisition unit 3. The recognition unit 5 extracts feature points from the captured images and recognizes at least one of recognition target objects included in the images acquired by the acquisition unit 3, by associating the extracted feature points (may be called second feature points or a second feature point group) with feature points of recognition target objects, stored in the storage unit 4. Note that the relevant processing corresponds to a step S303 in the flowchart illustrated in FIG. 3.

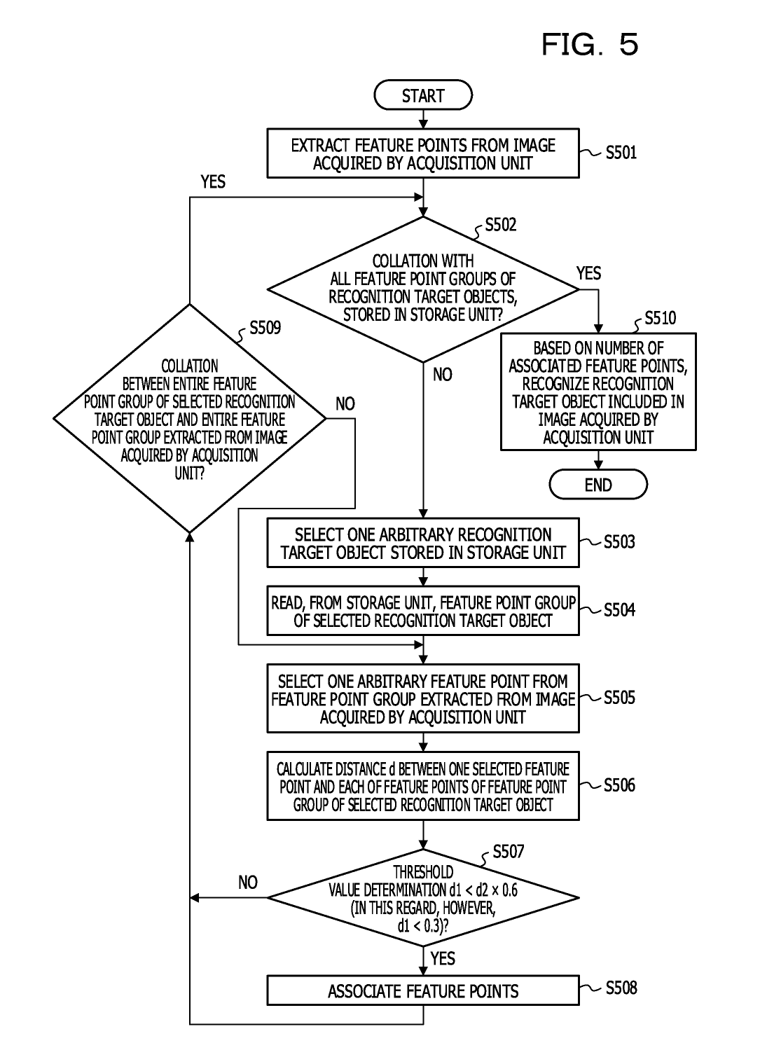

FIG. 5 is a flowchart of recognition processing of a recognition target object in the recognition unit 5. Note that the flowchart illustrated in FIG. 5 corresponds to a detailed flowchart of the step S303 in FIG. 3. First, the recognition unit 5 receives, from the acquisition unit 3, captured images whose acquisition times are different, and extracts feature points from each of the captured images (every frame) (step S501). Note that since usually the number of the extracted feature points is two or more, a set of feature points may be defined as a feature point group.

Each of feature points extracted in the step S501 only has to be a feature point in which a feature amount vector of the relevant feature point, called a descriptor, is calculated. For example, scale invariant feature transform (SIFT) feature points or speeded up robust features (SURF) feature points may be used. Note that an extraction method for the SIFT feature points is disclosed in, for example, U.S. Pat. No. 6,711,293. An extraction method for the SURF feature points is disclosed in, for example, “Bay H. et al., “SURF: Speeded Up Robust Features,” Computer Vision and Image Understanding, Vol. 110, No. 3, pp. 346-359, 2008”.

Next, the recognition unit 5 determines whether or not collation between the feature point group (may be called the second feature point group), extracted by the recognition unit 5 in the step S501, and all feature point groups of candidates for recognition target objects, stored in the storage unit 4, is completed (step S502). Note that it is assumed that as for the feature point groups of recognition target objects, stored in the storage unit 4, the above-mentioned SIFT feature points or SURF feature points are preliminarily stored. In a case where the collation is not completed in the step S502 (step S502: No), the recognition unit 5 selects one arbitrary recognition target object preliminarily stored in the storage unit 4 (step S503). Next, the recognition unit 5 reads, from the storage unit 4, a feature point group of the recognition target object selected in the step S503 (step S504). The recognition unit 5 selects one arbitrary feature point from the feature point group extracted in the step S504 (step S505).

The recognition unit 5 searches for an association between the one feature point selected in the step S505 and the feature point of the recognition target object read and selected in the step S504. As a search method, matching processing based on general correspondence point search may be used. Specifically, the recognition unit 5 calculates a distance d between the one feature point selected in the step S505 and each of feature points of the feature point group of the recognition target object selected in the step S504 (step S506).

Next, the recognition unit 5 performs threshold value determination in order to perform determination of validity of the association between feature points. Specifically, in the step S506, the recognition unit 5 calculates a minimum value d1 of the calculated distance d and a second minimum d2 thereof. In addition, the recognition unit 5 determines whether or not a condition that a distance between the d1 and the d2, which serves as the threshold value determination, is greater than or equal to a predetermined distance (for example, the d1 is a value smaller than a value obtained by multiplying the d2 by 0.6) and the d1 is less than or equal to a predetermined value (for example, less than 0.3) is satisfied (step S507). In a case where the condition of the threshold value determination is satisfied in the step S507 (step S507: Yes), the recognition unit 5 associates feature points with each other (step S508). In a case where the condition of the threshold value determination is not satisfied (step S507: No), the association of feature points is not performed and the processing proceeds to a step S509.

The recognition unit 5 determines whether collation between the entire feature point group read in the step S504 and the entire feature point group extracted in the step S501 is performed (step S509). In a case where collation processing is completed (step S509: Yes), the recognition unit 5 moves the processing to a step S510 in a case where the entire collation finishes in the step S502 (step S502: Yes). In a case where the collation processing does not finish (step S509: No), the recognition unit 5 moves the processing to the step S505. In addition, based on the number of feature points associated in the step S508, the recognition unit 5 recognizes a recognition target object included in the corresponding image acquired by the acquisition unit 3 (step S510). Note that the feature point group, associated in the step S508 and stored in the storage unit 4, may be called the first feature points or the first feature point group.

In this way, the recognition unit 5 recognizes, from a captured image acquired from the acquisition unit 3, a recognition target object included in the relevant captured image. Note that while not performing the above-mentioned recognition processing on all the images received from the acquisition unit 3, the recognition unit 5 is able to reduce processing costs by defining a key frame in which the recognition processing is performed at predetermined time intervals. In addition, in a case where an AR marker is assigned to a recognition target object, the recognition unit 5 is able to recognize the recognition target object by applying a general recognition method for the AR marker to a captured image acquired by the acquisition unit 3. The recognition unit 5 reads, from the storage unit 4, an additional information image corresponding to the recognized recognition target object and causes the display unit 8 to display the additional information image. Note that the display unit 8 places a corresponding pointer on the additional information image, thereby causing the display unit 8 to display the additional information image. Note that the relevant processing corresponds to a step S304 in the flowchart illustrated in FIG. 3.

Furthermore, the recognition unit 5 in FIG. 2 recognizes the operation part of the user, from the captured image received from the acquisition unit 3. Note that the relevant processing corresponds to a step S305 in the flowchart illustrated in FIG. 3. The operation part of the user is, for example, a finger of a hand (a dorsum of the hand may be included). As a method for recognizing a finger of a hand, the recognition unit 5 is able to use a method, disclosed in, for example, Japanese Patent No. 3863809 and used for estimating, based on image processing, a hand-finger position. In the first example, for convenience of explanation, it is assumed that the recognition unit 5 uses the method disclosed in the above-mentioned Japanese Patent No. 3863809, and subsequent explanation will be performed. In the relevant method, by selecting (extracting), for example, a skin-colored color component portion from an image received from the acquisition unit 3, the recognition unit 5 extracts a hand area outline. After that, after recognizing the number of fingers, the recognition unit 5 performs processing for recognizing a finger of a hand from the hand area outline. Note that for extraction of a skin-colored color component, the recognition unit 5 is able to use adequate threshold value adjustment of an RGB space or an HSV space.

In addition, the recognition unit 5 may recognize the operation part of the user, based on a luminance gradient feature amount such as a histogram of oriented gradients (HOG) feature amount or a local binary pattern (LBP) feature amount. Using a method disclosed in, for example, “Dalal N. et al., “Histograms of Oriented Gradients for Human Detection,” 2005 IEEE Computer Society Conference on Computer Vision and Pattern Recognition (CVPR), 2005.”, the recognition unit 5 may extract the HOG feature amount serving as an example of the luminance gradient feature amount. In addition, prior learning by a classifier is implemented using, for example, an image (positive image) in which a target object (a finger of a hand serving as an example of the operation part) is imaged and an image (negative image) in which the target object is not imaged, and known various learning methods by classifiers, such as Adaboost and a support vector machine (SVM), may be used. As the learning method by the classifier, it is possible to use a learning method by a classifier, which utilizes the SVM disclosed in, for example, “Dalal N. et al., “Histograms of Oriented Gradients for Human Detection,” 2005 IEEE Computer Society Conference on Computer Vision and Pattern Recognition (CVPR), 2005.”, described above. In addition, in a case where the recognition unit 5 recognizes one or more fingers of a hand, a finger of a hand recognized by the recognition unit 5 at the beginning may be defined as a processing target. The recognition unit 5 outputs, to the calculation unit 6, a recognition result relating to the recognition target object and the operation part.

The calculation unit 6 is, for example, a hardware circuit based on hard-wired logic. In addition, the calculation unit 6 may be a functional module realized by a computer program executed by the image processing device 1. The calculation unit 6 receives, from the recognition unit 5, the recognition result relating to the recognition target object and the operation part. The calculation unit 6 calculates a position of a finger of a hand of the user in a camera coordinate system, the finger of a hand being included in the captured image. After recognizing the number of fingers of a hand from, for example, the detected hand outline area, the calculation unit 6 is able to calculate hand-finger coordinates from the outline of the hand outline area. Note that, as a method for calculating the coordinates of a finger of a hand to serve as the operation part of the user, the calculation unit 6 may use a method in which learning data relating to the shape of a hand is preliminarily held and a hand-finger shape is estimated by calculating the degree of similarity between a captured image acquired at current time and the learning data, the method being disclosed in, for example, “Yamashita, et al., “Hand Shape Recognition Utilizing 3-Dimensional Active Appearance Model”, Image Recognition and Understanding Symposium, MIRU2012, IS3-70, 2012-08”. In addition, by defining an arbitrary reference point for the estimated finger of a hand, the calculation unit 6 is able to calculate the coordinates of the relevant reference point, as the coordinates of the finger of a hand. By elliptically approximating a finger of a hand from, for example, the outline of the hand outline area, the calculation unit 6 is able to calculate, as an ellipse center, the position of the finger of a hand.

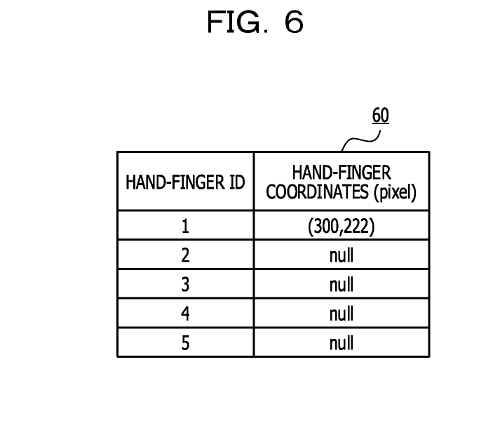

FIG. 6 is a table illustrating an example of a data structure including hand-finger coordinates in a camera coordinate system, calculated by the calculation unit 6. Note that the camera coordinate system in a table 60 in FIG. 6 is specified under the condition that a left upper end of a captured image is defined as an original point, a right direction of the captured image is defined as the positive direction of an x-axis, and a downward direction of the captured image is defined as the positive direction of a y-axis. Note that the table 60 in FIG. 6 is an example of the data structure in a case where there is assumed a state in which the captured image resolution of the image capturing unit 2 is 320 pixels wide and 240 pixels high and, in moving image capturing of 30 fps, a recognition target object exists about 60 cm ahead of the image capturing unit 2. In the table 60, the coordinates of a finger of a hand, calculated from a captured image in a case where a user sticks out, for example, only an index finger, is stored while being associated with a hand-finger ID. In this case, the index finger is associated with a hand-finger ID1. Note that while, in a case where the user spreads a hand, the coordinates of fingers of a hand are stored in hand-fingers ID1 to ID5, in this case the hand-fingers ID may be assigned in ascending order of coordinate in a lateral direction. Note that the reference point of each of hand-finger coordinates may be defined as, for example, the left upper end of a captured image. In addition, the table 60 may be stored in a cache or a memory in the calculation unit 6, not illustrated, and may be stored in the storage unit 4. Note that, in the first example, for convenience of explanation, processing in a case where the user sticks out only an index finger will be disclosed.

Using a method, illustrated below, as appropriate, the calculation unit 6 may calculate the gravity center position of a hand area. In a case where, as a calculation method for the gravity center position, the coordinates of a pixel Pi within a region Ps extracted as a skin-colored area in an image of, for example, a frame t are defined as (xi, t, yi, t) and the number of pixels is defined as Ns, the calculation unit 6 is able to calculate a gravity center position Gt(xt, yt) in accordance with the following Expression.

$${x}_{t} = \frac{1}{{N}_{s}} {\sum }_{Pi ∈ Ps} {x}_{i , t}$$

$${y}_{t} = \frac{1}{{N}_{s}} {\sum }_{Pi ∈ Ps} {y}_{i , t}$$

The calculation unit 6 calculates a feature amount of the operation part and the amount of change in the relevant feature amount. Note that the relevant processing corresponds to steps S306 and S307 in the flowchart illustrated in FIG. 3. In addition, the feature amount of the operation part is, for example, the length or area of a finger of a hand. The calculation unit 6 only has to implement the following calculation processing on a hand-finger ID whose hand-finger coordinates are stored in the table 60 in FIG. 6. In the first example, explanation will be performed under the assumption that the following calculation processing is implemented on the hand-finger ID1. By elliptically approximating a finger of a hand from, for example, the outline of the hand outline area, the calculation unit 6 is able to calculate the length or area of the finger of a hand. In addition, the calculation unit 6 calculates the position of the recognition target object in a captured image. As for the position of the recognition target object, by providing an arbitrary reference point for the recognition target object, it is possible to define the coordinates of the relevant reference point as the position of the recognition target object. Note that an arbitrary reference point may be provided at, for example, the center of the recognition target object. The calculation unit 6 outputs, to the recognition unit 5, the feature amount of the operation part and the amount of change in the feature amount of the operation part, which are calculated.

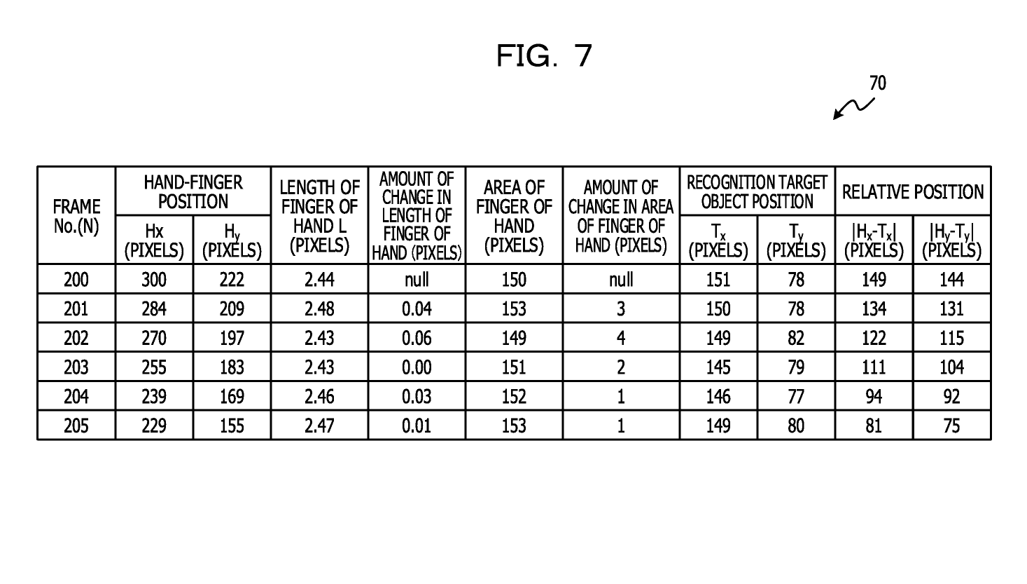

FIG. 7 is a diagram illustrating an example of a table including a data structure of feature amounts of an operation part, the amounts of change in the feature amounts of the operation part, and a position of a recognition target object, calculated by the calculation unit 6. Note that the calculation unit 6 is able to store a table 70 in FIG. 7 in a cache or memory in the calculation unit 6, not illustrated, or in the storage unit 4. In the table 70 in FIG. 7, for example, the left upper end of a captured image acquired by the acquisition unit 3 may be defined as an original point. Note that T_{X} and T_{Y} to serve as the positions of the recognition target object on an image and H_{X} and H_{Y} to serve as a hand-finger position in the table 70 in FIG. 7 are coordinates of an arbitrary reference point of the recognition target object with respect to the original point of an image in a lateral direction and a vertical direction and are measured in units of pixels. An arbitrary reference point of the recognition target object may be set at, for example, the center of the recognition target object. In addition, an arbitrary reference point of a finger of a hand may be set at, for example, an ellipse center in a case of elliptically approximating the shape of the finger of a hand. Note that the table 70 in FIG. 7 is an example of the data structure in a case where there is assumed a state in which the captured image resolution of the image capturing unit 2 is 320 pixels wide and 240 pixels high and, in moving image capturing of 30 fps, a recognition target object exists about 60 cm ahead of the image capturing unit 2. Furthermore, the table 70 in FIG. 7 illustrates a state in which the recognition unit 5 recognizes the recognition target object in a 200th frame in captured images and continuously recognizes the recognition target object in subsequent frames.

In a case where the length of a finger of a hand in an N-th frame is L_{N} in the table 70 in FIG. 7, the calculation unit 6 is able to calculate the amount of change in the length of a finger of a hand from a difference with respect to the length, L_{N-1}, of a finger of a hand in an N−1-th frame serving as a frame immediately preceding the N-th frame. Note that the amount of change in the length of a finger of a hand may be expressed by the following Expression.

The amount of change in the length of a finger of a hand=|L_{N}−L_{N-1}|

In a case where the area of a finger of a hand in the N-th frame is S_{N} in the table 70 in FIG. 7, the calculation unit 6 is able to calculate the amount of change in the area of a finger of a hand from a difference with respect to the length, S_{N-1}, of a finger of a hand in the N−1-th frame serving as a frame immediately preceding the N-th frame. Note that the amount of change in the area of a finger of a hand may be expressed by the following Expression.

The amount of change in the area of a finger of a hand=|S_{N}−S_{N-1}|

In the table 70 in FIG. 7, the calculation unit 6 is able to calculate relative positions between a finger of a hand and the recognition target object in the N-th frame, based on the following Expression.

Relative position (x-direction)=|H_{xN}−T_{xN}|

Relative position (y-direction)=|H_{yN}−T_{yN}|

The determination unit 7 is, for example, a hardware circuit based on hard-wired logic. In addition, the determination unit 7 may be a functional module realized by a computer program executed by the image processing device 1. The determination unit 7 receives, from the calculation unit 6, the feature amount of the operation part, the amount of change in the feature amount of the operation part, and so forth. Based on the amount of change in the feature amount of the operation part, the determination unit 7 determines whether a motion of the operation part is directed at the recognition target object or the additional information image. Note that the relevant processing corresponds to steps S308 to S310 in the flowchart illustrated in FIG. 3.

The determination unit 7 determines whether or not the amount of change in the length or area of a finger of a hand, which serves as an example of the amount of change in the feature amount of the operation part, is less than a preliminarily defined arbitrary first threshold value (step S308). Note that the first threshold value may be specified as, for example, the first threshold value=5 pixels in a case of using the amount of change in the area. In addition, the first threshold value may be specified as, for example, the first threshold value=0.07 images in a case of using the amount of change in the length. In a case where the amount of change in the feature amount of the operation part is less than the first threshold value (step S308: Yes), the determination unit 7 determines that the motion of the operation part of the user is directed at the additional information image (step S309). In addition, in a case where the amount of change in the feature amount of the operation part is greater than or equal to the first threshold value (step S308: No), the determination unit 7 determines that the motion of the operation part of the user is directed at the recognition target object in the real world (step S310). Note that the determination unit 7 may calculate the average value of the amounts of change in feature amounts over frames and may implement comparison processing with the first threshold value by using the relevant average value.

Here, an example of technical significance in the first example will be described. Since usually a pointer displayed in the display unit 8 two-dimensionally moves from right to left or up and down, a finger of a hand of the user turns out to planarly move to some extent. In other words, the amount of change in the area or length of a finger of a hand on an image decreases. On the other hand, in a case where the operation target of the operation part of the user is the recognition target object in the real world, work is implemented on a three-dimensional object. Therefore, while slightly depending on the content of the work, the amount of change in the area or length of a finger of a hand on an image turns out to greatly fluctuate. Therefore, if the amount of change in the area of a finger of a hand is less than the first threshold value, the operation target of the operation part of the user may be regarded as the additional information image. In addition, if the amount of change in the area of a finger of a hand is greater than or equal to the first threshold value, the operation target of the operation part of the user may be regarded as the recognition target object in the real world. Note that in a case where the image processing device 1 includes a ranging sensor, it is possible to determine the operation target of the user by measuring the amount of change in the position (depth) of a fingertip. However, since leading to an increase in cost, the measurement of the amount of change in the position of a fingertip is not desirable.

In a case of determining that the operation target of the operation part of the user is the additional information image in a virtual world, the determination unit 7 may move the pointer displayed in the display unit 8 in accordance with, for example, a hand-finger position illustrated in the table 70 in FIG. 7. Note that since usually the focal lengths of the recognition target object in the real world and the additional information image displayed by the display unit 8 are different, it is difficult for the user to simultaneously view the two. Therefore, the position of the fingertip and the position of the pointer on an image do not have to coincide with each other, and an operation in which the pointer relatively moves in response to the motion of the fingertip (for example, an operation in which the pointer moves up when the fingertip is moved up) only has to be realized.

In a case where the pointer performs a predetermined motion on the additional information image, the determination unit 7 is able to determine that a selection item of the additional information image is selected. In a case where, for example, the pointer is superimposed on a selection item during a predetermined time period or more, it is possible to determine that the selection item is selected. In addition, in a case where the user moves the pointer left to right a given distance or more in such a manner as superimposing the pointer on a selection item, it is possible to determine that the selection item is selected. In addition, in a case where there are many different selection items and all the selection items are able to be displayed in the additional information image, a second additional information image corresponding to the recognition target object may be displayed in a switching manner. In this case, using, as a trigger to switch display of the additional information image, a finger of a hand being moved right to left or a pointer being moved left to right a predetermined long distance, it is possible to perform determination.

In the image processing device 1 disclosed in the first example, it becomes possible to identify whether the operation target of the operation part of the user is the additional information image or the recognition target object, and it becomes possible to seamlessly switch between work in which the recognition target object that exists in the real world is an operation target and work in which the additional information image is an operation target. From this, it becomes possible to provide an image processing device that adequately displays the additional information image without reducing the work efficiency.

### Second Example

In addition to matters disclosed in the first example, the following matters are newly found out by earnest study of the present inventors. At the time of operating the pointer of the additional information image, the user operates the pointer in a state of bending an elbow to some extent. In other words, at the time of operating the pointer of the additional information image, the user does not operate the pointer in a state of straightening an elbow. Therefore, in a case where the additional information image is the operation target, a distance between the image capturing unit 2 fixedly supported by or attached on the cervical part of the user and a finger of a hand decreases, compared with the time of performing work on the recognition target object in the real world. The opinion of the present inventors in this event will be illustrated hereinafter.

In a case where the operation target of the operation part of the user is the additional information image, the user views only the additional information image and visually recognizes a pointer in which a fingertip position is reflected. In this case, the user does not visually recognize a fingertip in the real world. This results from a difference between the focal lengths of the additional information image and the fingertip in the real world. In other words, since the focal lengths of the additional information image and the fingertip in the real world are different from each other, it is difficult to simultaneously visually recognize the fingertip in the real world and the additional information image. At the time of viewing, for example, the additional information image, the user views a blurred finger. In contrast, at the time of viewing the fingertip in the real world, the user views the blurred additional information image. Therefore, at the time of regarding the additional information image as the operation target, the user operates the pointer at a position (a state of bending an elbow to the extent that it is possible to widen the range of motion) at which the user most easily operates, regardless of the focal length of the recognition target object.

Using the above-mentioned feature, in a case where the feature amount of the operation part of the user is greater than or equal to an arbitrarily defined second threshold value, the determination unit 7 is able to determine that the operation target is the additional information image. In addition, using the above-mentioned feature, in a case where the feature amount of the operation part of the user is less than the second threshold value, the determination unit 7 is able to determine that the operation target is the recognition target object. In addition, the feature amount of the operation part of the user is the length of a finger of a hand or the area of a finger of a hand. Note that in a case of using, as the feature amount, the area of a finger of a hand, the second threshold value may be set to, for example, the second threshold value=50 pixels. In addition, in a case of using, as the feature amount, the length of a finger of a hand, the second threshold value=2 pixels may be defined. Note that the determination unit 7 may calculate the average value of feature amounts over frames and may implement comparison processing with the second threshold value by using the relevant average value. In addition, in a case where the second threshold value is further divided and, for example, the area of a finger of a hand is set as the feature amount, the determination unit 7 is able to determine, in a case of being greater than or equal to 100 pixels, that the operation target is the additional information image, and the determination unit 7 is able to determine, in a case of being less than 30 pixels, that the operation target is the recognition target object in the real world. Note that, to specify the second threshold value, the degree of determination accuracy may be improved by preliminarily registering, for each of users, a feature amount in a case of preliminarily defining the additional information image as an operation target and a feature amount in a case of defining the recognition target object as an operation target.

In addition to the determination processing in the determination unit 7 disclosed in the first example, by combining determination processing disclosed in the second example, it becomes possible to further improve the degree of determination accuracy of the determination unit 7. In a case where, for example, the amount of change in the feature amount of the operation part is less than the first threshold and the feature amount is greater than or equal to the second threshold value, the determination unit 7 may determine that the operation target is the additional information image. In a case where the user performs work on the recognition target object in the real world in, for example, a state of straightening an elbow (work for writing characters on a whiteboard, or the like), a peculiar state such as a case where the motion of a finger of a hand is substantially two-dimensional is removed based on the relevant determination processing, thereby enabling the operation target of the operation part of the user to be determined.

### Third Example

In addition to matters disclosed in the first example or the second example, in a case where relative positions between the recognition target object and the operation part are greater than or equal to an arbitrarily specified third threshold value, the determination unit 7 may determine that the operation target of the operation part of the user is the additional information image. In this case, the determination unit 7 only has to reference relative positions illustrated in the table 70 in FIG. 7. In addition, the third threshold value may be specified as, for example, 150 pixels, and in a case where both the relative positions in the x-direction and the y-direction are greater than or equal to the third threshold value, a condition may be regarded as being satisfied. In a case where a work target object in the real world is set as the operation target, a finger of a hand of the user runs out to be in contact with the work target object or be close thereto. Therefore, in addition to the determination processing in the determination unit 7 disclosed in the first example or the second example, by combining determination processing disclosed in the third example, it becomes possible to further improve the degree of determination accuracy of the determination unit 7. In a case where, for example, the amount of change in the feature amount is less than the first threshold and the relative positions between the recognition target object and the operation part are greater than or equal to the third threshold value, the determination unit 7 may determine that the operation target is the additional information image.

Note that the determination unit 7 may calculate the average values of relative positions over frames and may implement comparison processing with the third threshold value by using the relevant average values. Two-dimensional relative positions between a fingertip and the recognition target object do not significantly change as long as a finger of a hand is in contact with the recognition target object. Therefore, by calculating the average values of relative positions over frames and implementing comparison processing with the third threshold value by using the relevant average values, it becomes possible to further improve the degree of determination accuracy of the determination unit 7.

### Fourth Example

In a case where the recognition unit 5 further recognizes a first shape of the operation part of the user and the first shape coincides with a preliminarily defined second shape, the determination unit 7 may determine that the operation target of the operation part of the user is the additional information image. Specifically, the recognition unit 5 may recognize the first shape in accordance with, for example, the number of hand-finger IDs whose fingertip coordinates are stored in the table 60 in FIG. 6. In addition, the determination unit 7 may preliminarily define, as the second shape, a shape in a case where the fingertip coordinates are stored in, for example, only the fingertip ID1 (for example, in a case where the user sticks out only an index finger). In a case where the first shape and the second shape coincide with each other, the determination unit 7 may recognize that the user performs an operation on the additional information image. On the other hand, in a case where a finger of a hand has a shape other than the second shape (in a case where a hand is spread and fingertip coordinates are stored in all the fingertips ID1 to ID5), the determination unit 7 may determine that the operation target of the operation part of the user is the recognition target object in the real world. Note that in a case where the user sticks out only an index finger, it is possible to give notice to the user by causing the display unit 8 to preliminarily display a message to the effect that it is possible to operate the pointer of the additional information image.

### Fifth Example

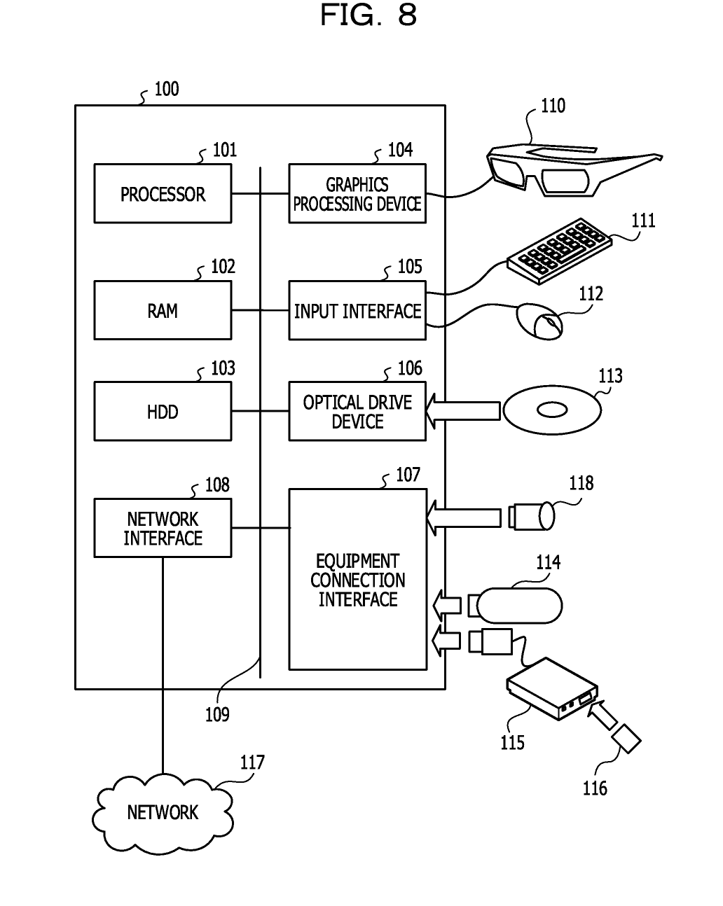

FIG. 8 is a hardware configuration diagram of a computer that functions as the image processing device 1 according to one embodiment. As illustrated in FIG. 8, the image processing device 1 includes a computer 100 and input-output devices (peripheral devices) connected to the computer 100.

The entire device of the computer 100 is controlled by a processor 101. A random access memory (RAM) 102 and peripheral devices are connected to the processor 101 via a bus 109. Note that the processor 101 may be a multiprocessor. In addition, the processor 101 is, for example, a CPU, a micro processing unit (MPU), a digital signal processor (DSP), an application specific integrated circuit (ASIC), or a programmable logic device (PLD). Furthermore, the processor 101 may be a combination of two or more elements out of the CPU, the MPU, the DSP, the ASIC, the PLD. Note that the processor 101 may perform processing operations of functional blocks such as, for example, the acquisition unit 3, the recognition unit 5, the calculation unit 6, the determination unit 7, and the processing unit 9 described in FIG. 2 or FIG. 3.

The RAM 102 is used as a main storage device of the computer 100. In the RAM 102, at least part of a program of an operating system (OS) and application programs that are caused to be executed by the processor 101 is temporarily stored. In addition, in the RAM 102, various kinds of data to be used for processing based on the processor 101 are stored. As the peripheral devices connected to the bus 109, there are a hard disk drive (HDD) 103, a graphics processing device 104, an input interface 105, an optical drive device 106, an equipment connection interface 107, and a network interface 108.

The HDD 103 magnetically performs writing and reading of data on embedded disks. The HDD 103 is used as, for example, an auxiliary storage device of the computer 100. In the HDD 103, the program of the OS, the application programs, and various kinds of data are stored. Note that, as the auxiliary storage device, a semiconductor storage device such as a flash memory may be used. Note that the HDD 103 is able to perform processing in the functional block of the storage unit 4 described in FIG. 2 or FIG. 4.

A monitor 110 is connected to the graphics processing device 104. In accordance with an instruction from the processor 101, the graphics processing device 104 causes various kinds of images to be displayed in the screen of the monitor 110. As the monitor 110, the optical see-through display such as a half mirror, which has given reflectance and transmittance, may be used. Note that the monitor 110 may be supported by a frame so as to be attachable to the user. In addition, the monitor 110 may perform processing in the functional block of the display unit 8 described in FIG. 2 or FIG. 4.

A keyboard 111 and a mouse 112 are connected to the input interface 105. The input interface 105 transmits, to the processor 101, signals from sent from the keyboard 111 and the mouse 112. Note that the mouse 112 is an example of a pointing device and other pointing devices may be used. As the other pointing devices, there are a touch panel, a tablet, a touch pad, a trackball, and so forth.

Using laser light or the like, the optical drive device 106 reads data recorded in an optical disk 113. The optical disk 113 is a portable recording medium in which data is recorded so as to be readable by reflection of light. Examples of the optical disk 113 include a digital versatile disc (DVD), a DVD-RAM, a compact disc read only memory (CD-ROM), and a CD-recordable (R)/rewritable (RW). A program stored in the optical disk 113 serving as a portable recording medium is installed to the image processing device 1 via the optical drive device 106. The installed predetermined program becomes executable by the image processing device 1.

The equipment connection interface 107 is a communication interface for connecting peripheral devices to the computer 100. For example, a memory device 114 and a memory reader/writer 115 are connectable to the equipment connection interface 107. The memory device 114 is a recording medium in which a communication function with the equipment connection interface 107 is mounted. The memory reader/writer 115 is a device that writes data to a memory card 116 or reads data from the memory card 116. The memory card 116 is a card-type recording medium. In addition, a camera 118 is connectable to the equipment connection interface 107. Note that the camera 118 may perform processing in the functional block of the image capturing unit 2 described in FIG. 2 or FIG. 4. In addition, the camera 118 may be arranged so as to be integrated with the monitor 110.

The network interface 108 is connected to a network 117. The network interface 108 transmits and receives data to and from another computer or another communication device via the network 117.

By executing a program recorded in, for example, a computer-readable recording medium, the computer 100 realizes the above-mentioned image processing function. A program that describes the content of processing caused to be performed by the computer 100 may be recorded in various recording media. The above-mentioned program may be configured by one or more functional modules. The program may be configured by functional modules that realize processing operations in, for example, the acquisition unit 3, the recognition unit 5, the calculation unit 6, the determination unit 7, and so forth described in FIG. 2 or FIG. 4. Note that a program caused to be executed by the computer 100 may be stored in the HDD 103. The processor 101 loads, in the RAM 102, at least some of programs within the HDD 103 and executes the programs. In addition, a program caused to be executed by the computer 100 may be recorded in a portable recording medium such as the optical disk 113, the memory device 114, or the memory card 116. After being installed to the HDD 103 by control from, for example, the processor 101, the program stored in the portable recording medium becomes executable. In addition, the processor 101 may directly read the program from the portable recording medium and execute the program.

Individual configuration elements in individual devices graphically illustrated above do not have to be physically configured as illustrated in drawings. In other words, a specific embodiment of the distribution or integration of the individual devices is not limited to one of examples illustrated in drawings, and all or part of the individual devices may be configured by being functionally or physically integrated or distributed in arbitrary units according to various loads and various statuses of use. In addition, preliminarily prepared programs are executed by a computer such as a personal computer or a workstation, thereby enabling various kinds of processing described in the above-mentioned examples to be realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing device comprising:
a processor; and
a memory which stores a plurality of instructions, which when executed by the processor, cause the processor to execute:
acquiring an captured image including a recognition target object in a real world and an operation part of a user;
recognizing the recognition target object and the operation part from the captured image;
displaying an additional information image including information corresponding to the recognition target object; and
determining, based on the amount of change in a feature amount of the operation part in the captured images, whether a motion of the operation part is directed at the recognition target object or is directed at the additional information image.

2. The image processing device according to claim 1,
wherein the feature amount is a length or an area of the operation part,
wherein the determining
determines, in a case where the amount of change in the length or the area is less than a first threshold value, that the motion is directed at the additional information image, and
determines, in a case where the amount of change is greater than or equal to the first threshold value, that the motion is directed at the recognition target object.

3. The image processing device according to claim 2, wherein
in a case where the amount of change is less than the first threshold value and the feature amount is greater than or equal to a second threshold value, the determining determines that the motion is directed at the additional information image.

4. The image processing device according to claim 2, wherein
in a case where the amount of change is less than the first threshold value and a relative position between the recognition target object and the operation part is greater than or equal to a third threshold value, the determining determines that the motion is directed at the additional information image.

5. The image processing device according to claim 1, wherein
the displaying further displays a pointer corresponding to the additional information image, and
in a case where the motion is directed at the additional information image, the determining controls a display position of the pointer, based on a position of the operation part in the captured image.

6. The image processing device according to claim 1, wherein
the recognizing further recognizes a first shape of the operation part, and
in a case where the first shape coincides with a preliminarily defined second shape, the determining determines that the motion is directed at the additional information image.

7. An image processing method comprising:
acquiring an captured image including a recognition target object in a real world and an operation part of a user;
recognizing, by a computer processor, the recognition target object and the operation part from the captured image;
displaying an additional information image including information corresponding to the recognition target object; and
determining, based on the amount of change in a feature amount of the operation part in the captured images, whether a motion of the operation part is directed at the recognition target object or is directed at the additional information image.

8. The image processing method according to claim 7,
wherein the feature amount is a length or an area of the operation part,
wherein the determining
determines, in a case where the amount of change in the length or the area is less than a first threshold value, that the motion is directed at the additional information image, and
determines, in a case where the amount of change is greater than or equal to the first threshold value, that the motion is directed at the recognition target object.

9. The image processing method according to claim 8, wherein
in a case where the amount of change is less than the first threshold value and the feature amount is greater than or equal to a second threshold value, the determining determines that the motion is directed at the additional information image.

10. The image processing method according to claim 8, wherein
in a case where the amount of change is less than the first threshold value and a relative position between the recognition target object and the operation part is greater than or equal to a third threshold value, the determining determines that the motion is directed at the additional information image.

11. The image processing method according to claim 7, wherein
the displaying further displays a pointer corresponding to the additional information image, and
in a case where the motion is directed at the additional information image, the determining controls a display position of the pointer, based on a position of the operation part in the captured image.

12. The image processing method according to claim 7, wherein
the recognizing further recognizes a first shape of the operation part, and
in a case where the first shape coincides with a preliminarily defined second shape, the determining determines that the motion is directed at the additional information image.

13. A non-transitory computer-readable medium that stores an image processing program for causing a computer to execute a process comprising:
acquiring an captured image including a recognition target object in a real world and an operation part of a user;
recognizing the recognition target object and the operation part from the captured image;
displaying an additional information image including information corresponding to the recognition target object; and
determining, based on the amount of change in a feature amount of the operation part in the captured images, whether a motion of the operation part is directed at the recognition target object or is directed at the additional information image.
